(19) United States
(12) Patent Application Publication
(10) Pub. No.: US 2020/0285856 A1
(43) Pub. Date: Sep. 10, 2020

(54) VIDEO ROBOT SYSTEMS

(71) Applicant: AMARIS.AI PTE. LTD., Singapore (SG)

(72) Inventors: Khue Hiang CHAN, Singapore (SG); Chien Siang YU, Singapore (SG)

(21) Appl. No.: 16/795,532

(22) Filed: Feb. 19, 2020

Related U.S. Application Data
(60) Provisional application No. 62/807,248, filed on Feb. 19, 2019.

(51) Int. Cl. G06K 9/00; G06N 3/04; G06N 3/08

(52) U.S. Cl. CPC G06K 9/00684; G06N 3/0445; G06K 2009/00738; G06K 9/00718; G06N 3/08

(57) ABSTRACT

An artificial intelligence (AI) system or software AI platform that is capable of performing video analytics and image processing. The system, which may be referred to as a video robot system, may be employed to view video feeds to detect events and objects without humans. The video robot system enables real-time monitoring of video feeds with high accuracy and low false detection (errors). The system is able to detect and discern complex action sequences that will lead to greater granular process automation and response reactions.

### CROSS-REFERENCE TO RELATED APPLICATION

This application claims the benefit of U.S. Provisional Application No. 62/807,248, filed on Feb. 19, 2020, which is incorporated herein by reference in its entirety for all purposes.

### FIELD OF THE INVENTION

The present disclosure relates to video robots. In particular, the present disclosure relates to the use of video robots to perform artificial intelligence (AI) video analytics and image processing.

### BACKGROUND

Many companies, such as banks, are faced with high operational costs in protecting physical assets, ensuring safety procedures and in using humans for managing customers at counters. With the continued decrease in costs of video equipment, deployment of video cameras and recording infrastructure for both incident investigation and active backend monitoring have increased. For example, automated teller machines (ATMs) have video recorders for attack attribution and root cause investigation

However, conventional techniques for reviewing videos as part of investigation are time intensive and costly. In some cases, security personnel may be required to monitor the video feeds to detect incidences as they occur or to determine suspicious activities, further increasing cost. In addition, human monitoring is prone to human error as the security personnel may miss something from the video feeds.

From the foregoing discussion, there is a need to enable reviewing of video feeds efficiently and accurately to investigate past incidents as well as cost-effective accurate real-time monitoring of video feeds.

### SUMMARY

Embodiments generally relate to methods and systems for video robots. In particular, the video robot system is an AI system or software AI platform that is capable of performing video analytics and image processing.

In one embodiment, a method for performing automated video analysis includes receiving input data from different data sources, processing the input data which includes identifying and extracting information based on a predefined purpose The method further includes performing analytics using the information and performing analytics includes identifying one or more scenarios to determine a situation. The method proceeds to generate a correct preventive plan based on the determined situation. The automated video analysis is configured to simplify multimedia processing of complicated multi-state actions embedded within a video.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various embodiments. In the following description, various embodiments of the present disclosure are described with reference to the following, in which:

FIG. 1 shows an overview of an embodiment of a system architecture of a video robot system;

FIG. 2 illustrates various exemplary embodiments of the video robot system;

FIGS. 3a-b show exemplary workflows of the video robot system;

FIG. 4 illustrates an exemplary embodiment of an optimize flow for efficient processing;

FIG. 5 shows an exemplary workflow for forming integrated datasets;

FIGS. 6a-b show exemplary processing processes of the video robot system;

FIG. 7 shows an exemplary embodiment of the video robot system;

FIG. 8 shows various exemplary embodiments of the video robot system for an exemplary scenario of a fire; and

FIG. 9 represents an exemplary example of an input data.

### DETAILED DESCRIPTION

Embodiments described herein generally relate video robot systems. In particular, the video robot system is an AI system or software AI platform that is capable of performing video analytics and image processing. For example, a video robot system may be employed to view video feeds to detect events and objects without humans. The video robot system enables real-time monitoring of video feeds with high accuracy and low false detection (errors). The system is able to detect and discern complex action sequences that will lead to greater granular process automation and response reactions.

Utilizing AI models or algorithms, such as deep neural networks (DNNs) and/or machine learning, including generative adversarial networks (GANs), the video robot software system guides an operator in selecting the best usage and best approach to implement various forms of scene detection, object recognition and counting, pose/gait detection to resolve what people are doing with their gestures and arms and finally how acoustic sound can be used to improve accuracy and fuse all the parts into a complex narrative so that the responder can benefit from its precise reporting. The solution includes the use of existing and newly developed AI algorithms.

As new AI algorithms are created to improve performance, developers can adopt a first to use approach for the video robot system. For example, new AI algorithms may be implemented to provide more accurate and faster object recognition, more efficient memory usage or are able to integrate multiple recognition capabilities in a single pass.

However, to ensure that new AI algorithms do not negatively impact the system, real-time system requirements are strictly adhered to. For example, the system with the new AI algorithm goes through extensive testing and validation before it is implemented. This produces new integrations that will be unique and well adapted to the improvements possible via using new AI algorithms.

As an example, when responding to a bank robbery, it would be vital to highlight various salient information, such as, how many attackers, are they armed and what weapons do they have, how are they threatening to harm the branch staff, and what direction they have escaped towards. If there are cameras in the neighborhood, these cameras can be called in to track the escape route.

In one embodiment, the video robot system serves as an automation toolbox, enabling complex actions and behaviors to be automatically defined, generated and tested. The system allows a low skilled operator to quickly develop and tune a complicated multi-state action detection system, thereby saving implantation time and high cost associated with AI development.

The video robot system is configured for rapid development and deployment for advanced video analytics operational rollouts. The system, for example, is configured to train and guide a video analytics developer to select the most optimal AI video processing so as to tune and to automatically configure a software AI platform that will operate video feeds from existing or new IP cameras, including webcams. Since camera systems may run AI either at a backend or at the edge, there may be constraints, such as power consumption constraints, CPU type compatibility or embedded platform deployment. The video robot system performs automated optimization to meet the various constraints.

As part of the development process, a human designer defines the purpose or the function of the system, such as what the system is configured to do or perform. The designer may use various techniques or approaches, such as a text stick figure narrative or a show sample as an input to the system, to define the purpose of the system. For example, the input from the designer is used to train the AI system to detect and define the outcome workflow for the required actions, such as alerting or specific human tracking. The AI system is configured to guide the designer in a user-friendly manner, despite not knowing much about the algorithms that will be configured internally. The AI system is configured to automatically run models simulation and combine different AI models in sequence for best accuracy and workflow. The AI system is also configured to tune for the best operation, with choices given to the designer. As such, the AI system actively interacts with the designer to “compile” a video solution that is fit for the intended purpose.

Typical use cases are beyond the standard video analytics, like crossing a virtual box or fence or motion detection, are based on sophisticated AI to detect poses, text in scenes, gestures, pointings, emotions, specific objects detection, object counting indicating crowding, and specific behaviors, such as fighting, throwing objects or robbery with weapons. The system is capable of automatically handling challenging image processing issues to improve AI feature detection, such as noise removal, contrast/brightening, motion compensation, inadequate image resolution, as well as other types of image issues.

In addition, a resource allocation schedule allocating computational resources for the execution of different models may be generated, based on the requirements of the video processing issue. Results of the execution of the selected AI models and procedures in accordance with the resource allocation schedule may be obtained. Based on the results, an optimized computer vision operational model for the problem can then be selected. Automated testing of the target AI models can proceed automatically, with the ability to access validation of images and videos from an integrated, internal video training and validation database. In the event that there is not enough data available, the system may be configured to reach out to the Internet and download additional resources.

The video robot system has the ability to transfer its video knowhow to physical robots or external authenticated parties/partners who can then run remote monitoring tasks such as giving chase to robbers. In gist, this implies an “openness” that allows external entities such as the police or IoT Command systems, to collaborate with the video robot system securely as well as to inter-operate via new standards to send out dynamic downloads such as meta programs for robotic actions.

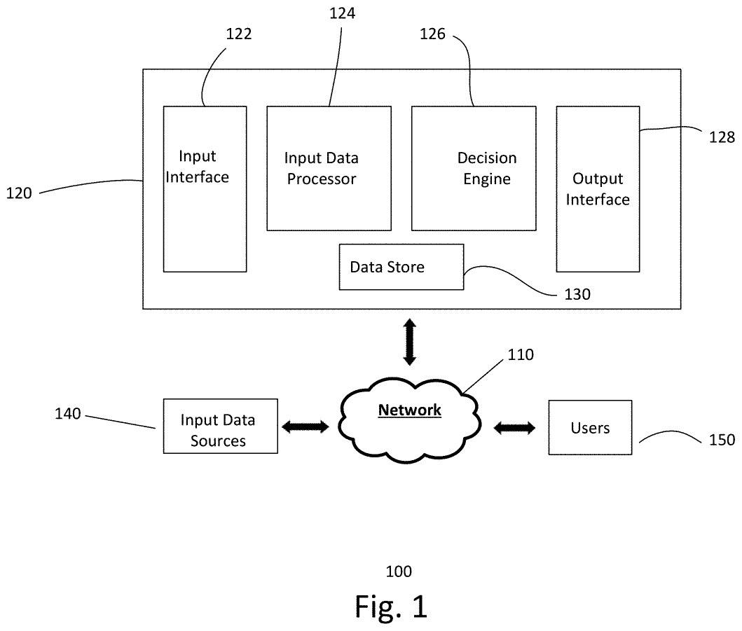

FIG. 1 shows a simplified framework 100 of a video robot platform or system 120. The video robot platform includes a cognitive system 120 which is communicatively coupled to a network 110. The communication network may be, for example, the internet. Other types of communication networks, including telecommunication networks, or a combination of networks may also useful. The cognitive system, for example, may be cloud-based. For example, the cognitive system may reside on one or more servers on a cloud.

A server may include one or more computers. A computer includes a memory and a processor. The memory of a computer may include any memory or a database module. The memory may be volatile or non-volatile types of non-transitory computer-readable media such as magnetic media, optical media, random access memory (RAM), read-only memory (ROM), removable media, or any other suitable local or remote memory component. In the case where the server includes more than one computer, they are connected through a communication network such as internet, intranet, local area network (LAN), wide area network (WAN), or a combination thereof. The servers, for example, may be part of a same private network. The servers may be located in single or multiple locations. Other configurations of servers may also be useful. For example, the servers may form a cloud.

Users 150 may access the video robot system using client or user devices via the communication network. A client or user device may be any computing device. A computing device, for example, includes a local memory and a processor. The computing device may further include a display. The display may serve as an input and output component of the user device. In some cases, a keyboard or pad may be included to serve as an input device. The memory may be volatile or non-volatile types of non-transitory computer-readable media such as magnetic media, optical media, RAM, ROM, removable media, or any other suitable memory component. Various types of processing devices may serve as user devices. For example, the user devices may include a personal computer, or a mobile client device such as a smart phone. Other types of user devices, such as laptops or tablets may also be useful.

There may be various types of users who may access the video robot system. For example, designer and requestor users may access the video robot system. A designer user, for example, defines the purpose or function of the video robot system. For example, the designer defines what the system is configured to do. Defining the function of the video robot includes providing the system with input, such as a narrative using text and stick figures or a sample of a show (show sample), to train the system to detect and define an output workflow.

Once the system is trained and capable of performing the intended or designed function, the system is deployed. Once deployed, a requestor user may provide a video or video feed for the video robot system to perform video analytics. For example, the cognitive system performs video analytics of the video provided by the requestor user. Other types of users may access the video robot system. For example, players and actors may access the video robot systems as well. Players, for example, are entities that would be involved in a detected incident. For example, in the case of a fire, the fire department may be a player. As for actors, they are individuals associated with a player. In the case where a player is the fire department, actors are firemen of the fire department.

As discussed, a user may connect to a server using a client device. The user device may be referred to as a client side while the server may be referred to as a server side. A user may access the server by logging in the user's respective account with, for example, a password using a client device. The client device may have an application interface or user interface (UI) which is used to communicate with the server. Alternatively, a web browser on the client device may be used. Other techniques for accessing the server may also be useful.

In addition, the system may also be configured to receive input data from various sources 140 for processing. For example, input data from sources, such as cameras and sensors, provide input data for processing via the communication network. Other types of sources may also be useful. For example, other sources may include the internet. Video feeds, pictures, as well as other information, such as sound, motion and position may be provided by the sources.

As for cameras, they may be internet protocol (IP) cameras. Other types of cameras may also be useful. The cameras may be fixed cameras, for example, fixed on the side of a building, lamps, traffic lights as well as other fixed positioned objects. The cameras may also be mobile, such as mounted on a drone, mounted on a person or animal or from a satellite. Sensors may include various types of sensors, such as microphones, motion detectors, global positioning sensors, as well other types of sensors. Input data may be pushed to the system by the data sources for analysis, pulled by the system from the data sources to obtain input data for analysis, or a combination thereof.

The cognitive system 120 includes various modules for processing videos and to identify scenarios of the videos and determine a course of action based on workflow associated with the identified scenario. In one embodiment, the cognitive system includes an input interface module 122, an input data processor module 124, a decision engine module 126, an output interface module 128, and a memory module 130. The cognitive system may include other modules as well.

An interface for a human operator may be employed to define the intended purpose of the cognitive system. Defining the intended purpose may include describing the set of video/image detection and reactions for the system to detect and identify. In one embodiment, the operator may pick a template from a set of possible known video operations to indicate which actions are to be detected from the video/image and the workflow performed. Templates, for example, may be stored in the data store module. A template may be in the form of an animated stick figure or animated gif, which is like a PowerPoint template. The input interface module 122 interfaces with the users and data sources. In one embodiment, the input interface module serves as a lowest layer of the video robot system. The input interface, for example, is the data ingestion layer. The input interface includes an authenticator unit for authenticating that the data from users and data sources is from valid or authenticated users and data sources. The templates, for example, are part of the toolbox used to define the purpose of the system.

The input data processor module 124 is configured to process the input data. In one embodiment, the processor preprocesses the input data. Preprocessing, for example in case of a video or video feed, may include segmenting or parsing the video into individual frames or images. The images of a video may be tagged with information, such as sequences in the series of frames, location, source, time stamp, as well as other salient or pertinent information. Such information may be in the form of metadata. Other techniques for tagging the images may also be useful. In one embodiment, preprocessing also includes image enhancement, if necessary. For example, the processor module determines if an image requires enhancement. For example, in the case that an image is blurry, image enhancement is performed. Image enhancement may include illumination equalization, image sharpening as well as noise removal. Other image enhancement processes may also be included. Image enhancement may increase performance or accuracy of the video robot system.

The preprocessed images are processed. In one embodiment, the images are processed to detect various aspects based on an intended purpose or function (base definitions) of the video robot system. For example, the system processes the images based on definitions of target features in the images. The processing may include scene recognition, face recognition, including identity recognition, face pose, emotions as well as other attributes of the face of a person, people recognition which includes the number of people, emotions of the people as well as other attributes of the people within the images, text within the images, objects in the images, as well as sound detection in the images based on the definitions. For sound, it may be from a series of the images.

Analytics is performed on the images from the processor module by the decision engine module. For example, outputs from the processor module are combined to predict an output based on the predefined input from the operator. The decision engine module 126, for example, is configured to predict, identify or infer threats, anomalies, and issues based on the predefined operator input. In addition, the decision engine, based on the results of the analytics, devises a plan with corrective or preventative actions as well as identified players and actors who can facilitate to carry out the plan.

In one embodiment, the output interface 128 facilitates in notifying the necessary users, such as players and actors, to facilitate in carrying out the plan. For example, the output interface serves as an action interface. The system may interact with players, like external agencies and entities such as law enforcement, to act on its detected event and how the information should be sent out to relevant actors, for example, by email, application programming interface (API), and other communication techniques. The action interface is designed to be platform agnostic. This, for example, may enable the system to communicate and direct geo-tagged actors to perform corrective actions.

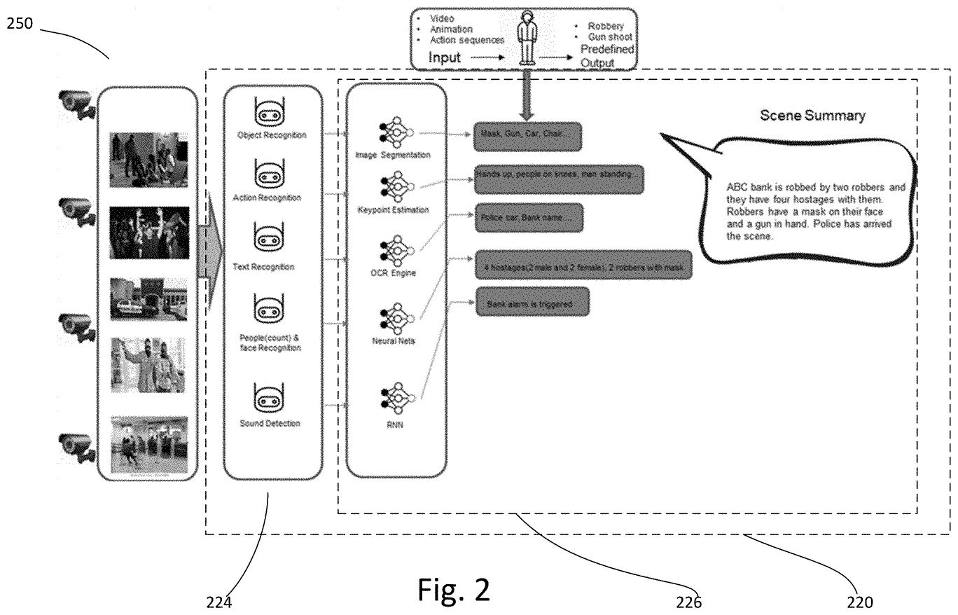

FIG. 2 shows an embodiment of a cognitive system 220 in greater detail. The cognitive system, in one embodiment, includes a processing module 224 and a decision engine module 226. For purposes of simplification, the input and output interface modules are not included. As shown, the cognitive system is configured to receive input data from one or more data sources 250. Data source may refer to using from one data source or a collective of multiple data sources. The data source can be a real-time or live data source (for example, live video feed), a non-real-time data source or a combination of both. The data source can be a multi-media data source with video, text, and sound. For example, the data source can be a multi-dimensional data source. Other types of data sources, such as single-dimension data sources may also be provided as input to the video robot system. The data source can be from cameras and/or sensors.

The processing module preprocesses and processes the input data from the data source. Preprocessing may include, in the case of a video or video feed, segmenting or parsing the video into individual frames or images. The images of a video may be tagged with information, such as a sequence in the series of frames, location, source, time stamp, as well as other salient or pertinent information. Such information may be in the form of metadata. Other techniques for tagging the images may also be useful. In one embodiment, preprocessing also includes image enhancement, if necessary. For example, the processor module determines if an image requires enhancement. For example, in the case that an image is blurry, image enhancement is performed. Image enhancement may increase performance or accuracy of the video robot system. Preprocessing may be achieved by preprocessing bots. Preprocessing bots, for example, are software bots configured to preprocess the input data. The bots may be distributed bots. For example, different bots are programmed to perform different preprocessing tasks.

In one embodiment, processing bots include an object recognition bot, a text recognition bot, an activity recognition bot, a face and people recognition bot, and a sound detection bot.

The object recognition bot recognizes objects using object recognition models stored in the data store module. In addition, the object recognition bot may also employ real-time object detection to perform semantic and instantaneous segmentation of different objects in the video frames. The object recognition bot enables tracking of where a person is going or a person's location with respect to other objects.

The text recognition bot employs AI optical character recognition (OCR). The AI OCR, in one embodiment, is augmented with handwritten character recognition. The text recognition bot can recognize text in the video or image frames.

As for the activity recognition bot, it is configured to recognize human poses. For example, human poses may be estimated by key points using real-time multi-person keypoint detection for body, face, hands, and foot positions, used in combination with past human traffic heatmap to recognize activities, gestures and actions. The face and people recognition bot is configured to support crowd counting, analyze crowd scenes with behaviors as well as facial expressions using Neural Networks trained on images annotated with humans and different facial expressions. The sound recognition bot may include neural networks for speech recognition. The neural networks are trained to detect alarms, screams as well as other sounds which are unusual. The sound recognition bot facilities in further enhancing the accuracy of the video frames analyzed by the video-centric bots.

The results of the processing module are combined and analyzed by the decision engine module 226. For example, the decision engine module analyzes the result to predict an output based on the predefined purpose by the designer or operator. In one embodiment, the decision engine module includes analytic units to predict the output of the results from the processing module.

In one embodiment, the decision engine includes an image segmentation unit, a keypoint estimation unit, an OCR engine, a neural nets unit and a recurrent neural network (RNN) unit. The various units may include AI functions. The units are configured to identify actions based on the defined purpose by the operator. For example, the decision engine is trained by the inputs from the operator or designer. The decision engine is trained to identify issues, such as threats, anomalies and issues in accordance with the operator input. In addition, the system generates a correct preventive action as well as identify the players and the actors who can mitigate the threat at hand.

The training may include the operator providing the system with templates, such as text stick figure narratives or show samples as an input to the system, to define the purpose of the system. For example, the input may be videos, animations and action sequences which are related to the purpose of the system. The system is trained by the input to determine the threats, anomalies and issues associated with the input. For example, the training may be for the system to identify a robbery or a firearm shooting. Based on the threat identified, the system is also trained to device an action plan, which is the defined ouput.

As an example, the image segmentation unit determines objects of the scene. For example, the objects include masks, guns, car and chair. The keypoint estimation unit identifies that there are people with their hands up, people on their knees, and people standing. The OCR engine unit identifies police on a car and name of the bank, such as ABC. The neural nets unit infers from the various images, that there are 4 hostages, 2 males and 2 females, as well as 2 robbers with masks. In addition, the RNN unit identifies that the alarm has been triggered at the bank. Based on the analytics from the analysis, the decision engine infers that ABC bank is being robbed by 2 armed masked robbers armed and that there are four hostages. In addition, the system infers that the police have arrived at the scene.

The cognitive system is configured with automated image processing and problem-solving with false-positive reduction. In one embodiment, the video robot system uses the defined detection targets based on the operator input to plan and select a set of possible image processing models for testing. The system, for example, simulates and assembles an optimized solution based on training results. The system also checks for the quality of the image and applies image enhancements, if necessary. The system validates which image processing model or algorithm is the best “fit”.

For example, the cognitive system automatically selects and sequence models for object or scene detection based on input from the operator. Based on the input, the cognitive system engineers and devises a strategy for false-positive reduction by creating scenarios for detection failures. For example, the test should result in a failure, such as one which wrongly indicates that a particular condition or attribute is present. As an example, one could mistake someone who is putting on a hat with both hands as one who has raised two hands as a surrender gesture. By understanding the failures, the system is able to develop solutions to eliminate known false positives and also be able to generically recognize them when these appear as unknown ones. Thus, the detection mechanism will be strengthened, yielding increased accuracy.

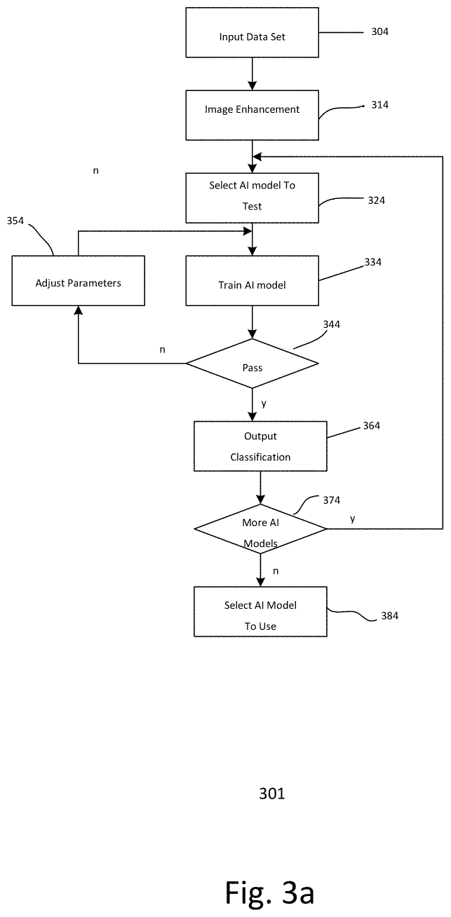

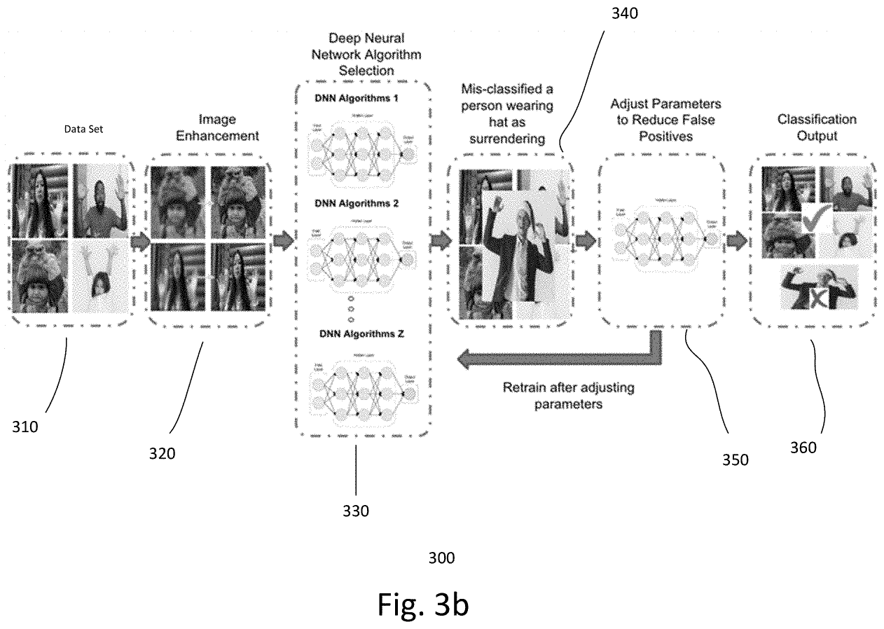

FIG. 3a shows an embodiment of a workflow 301 for reducing false positives by the video robot system. In one embodiment, the workflow for reducing false positives includes the operator providing a dataset for training at 304. The input data set is employed for training the video robot system. The system performs image classification or image segmentation. The system may automatically reduce false positives or choose a specific class to reduce false positives.

The data set, for example, includes images with annotations regarding the images. For example, each noise includes an annotation describing the image, such as its classification or classifications. In some cases, if an image does not have any annotations, the user may input an annotation for the image. For example, the system provides the user a choice to annotate an image before analytics is performed.

Preprocessing may be performed on the data set at 314. Preprocessing, for example, includes analyzing the images of the data set to determine its quality. If necessary, the system automatically enhances any image having inadequate image quality for training. The system, for example, checks the quality of all images in the data set and performs image enhancement on the images which need enhancement. Image enhancement may include illumination equalization, image sharpening and noise removal. Other image enhancement techniques may also be employed.

The cognitive system includes AI algorithms or models, such as Deep Neural Network (DNN) models. The AI models may reside in the storage module. The system selects an AI model at 324 to train the system at 334 using the data set. For example, the operator queries the cognitive system to identify images with a specific characteristic. Based on the query, the system analyzes the images using an AI model and determines which ones satisfies the query. At 344, the system determines if the AI model passes the training. For example, the system determines if the training score is above the passing threshold score defined by, for example, the operator. For example, the system determines if the AI model training results in sufficient accuracy or too many false positives. If the AI model fails the training, for example, insufficient accuracy, the system proceeds to 354.

At 354, the parameters of the AI model is adjusted to reduce false positives and proceeds to 334 for training. Various techniques may be employed to reduce false positives. For example, false positives may be reduced using reinforcement learning and generative adversarial networks (GAN). The process repeats until the AI model passes the training.

At 364, the training results are saved. The training results include, for example, classifications made by the AI model, score and duration of the training. The system determines if there are more AI models to be trained at 374. If there are, the system returns to 324 to select the next AI model to train. If not, the system proceeds to 384 to select an AI model to use for the analytics.

After training is completed, the AI model with the best performance is selected at 384. In one embodiment, performance may be based on the best accuracy (highest score). In other cases, the performance may be based on sufficient accuracy (above a minimum threshold) with the best time performance (shortest time). The user may provide the system with the performance requirements and the system selects the AI model that satisfies the operator's performance requirements. The system may provide the results to the operator and the operator may select the AI model based on the results. For example, the operator may select the AI model which is most important to relevant use case and optimize the model to further reduce the false positives of the most important events that must be detected. Alternatively, if time performance is important, the system may adopt time-related augmentation to the AI models to reduce false positives.

As an example, assume J is the cost function for the model. We can adjust the cost function J to J′ which will penalize hugely for the class which produces a high false positive. So the final cost function will be J and J′ put together. It is understood that the learning rate a for each class may be different. The longer learning rate will be for the class which has higher false positives. The operator can be given the option to choose which class is most important to the relevant use case and trains the model to reduce the false positives for that particular class.

FIG. 3b illustrates a use case 300 for training the video robot system. As shown, the use case is to identify a bank robbery based on people who have surrendered by raising their hands. At 310, an input data set is provided to the system. The input data set includes images in which people have both hands raised during a bank robbery as well as images which may be similar but are false positives. At 320, the system may perform image enhancement on the images, if necessary. An AI model, such as a DNN model, is selected from a plurality of AI models available for selection in the system for training at 330. The training at 340 results in a false positive, such as an image being misclassified. The system adjusts the parameter to reduce false positive at 350 and the training is repeated. The training is repeated until the training passes. For example, no error in the classification of the images occurs during the training. The results are saved and sent as output for the user at 360. The user may select the appropriate AI model for implementation.

The video robot system is configured to automatically optimize performance for efficient processing. For example, the video robot system deploys strategies to reduce computational and hardware cost when running complex workloads. For example, the video robot is configured to track video frames and process frames that have significant changes. This avoids the need for the video robot system to process all the frames of a video feed. The video robot may match algorithms based on the provided accuracy using embedded platforms such as CPUs, GPUs, and ASICs. In addition, the system may exploit cognitive system chips when available with cost recommendations as well as simulating processing loads and predict what will be required.

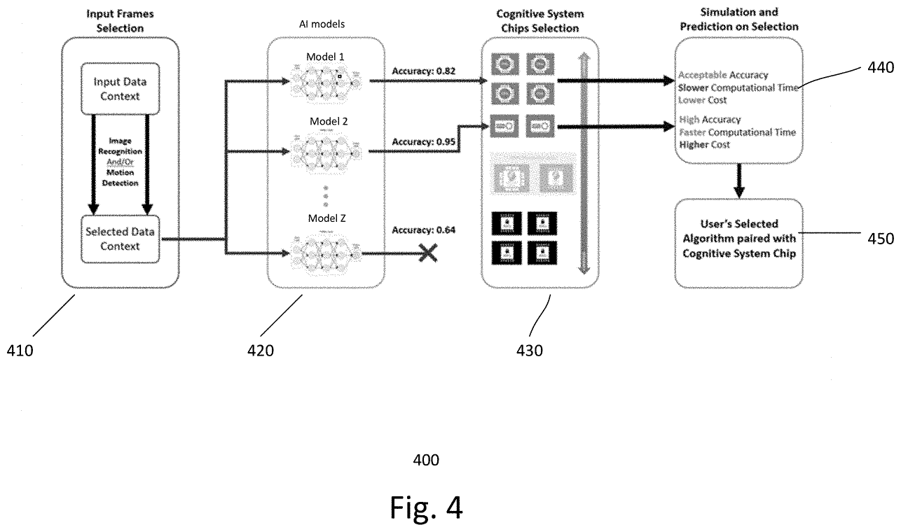

FIG. 4 shows an embodiment of an optimization process 400 for efficient processing by the video robot system. As shown, input data context at 410 can be either a video, a series of continuous or different images. The input data context is processed using image recognition or motion detection and output as selected data context. Selected data context, as discussed, includes images which have significant changes. At 420, the system includes various AI models, such as DNN models available for processing the selected data context. As shown, the system includes Model 1 to Model Z for selection by the operator to use for the analytics. The different models have different accuracy performance. Depending on the need of the operator, a lower accuracy performance model may be selected to reduce processing load. On the other hand, if high accuracy is required, the high accuracy model, such as model 1 is selected for processing.

The operator, at 430, may select the appropriate AI chips for processing. The selection may be based on cost recommendations and providing information related to predicted requirements. At 440, simulation and prediction on selected AI chips is performed. For example, the simulation predicts the accuracy, computational time required as well as associated cost. If the results of the simulation is acceptable, the operator's selected model and chip are employed for processing at 450.

As described, the video robot system provides flexibility by implementing strategies to effectively reduce computational time and hardware costs. The video robot system adopts the tools of cognitive systems, such as image recognition, motion detection and a vast list of deep neural networks algorithms, as essential components of operation which helps to enhance the selection of potentially noticeable difference in frames, DNN algorithms or models, and computational requirements. The workflow actively tracks the raw input video stream and selectively processes those frames with significant changes. Subsequently, an operator matches a best-fitted DNN algorithm based on accuracy trade-off and finds the most suitable chips with cost recommendations. Thus, providing advice on the predicted requirements via simulating of the processing loads.

The video robot, in one embodiment, is configured to exploit an internal database of images, videos and metadata to validate the AI models for expected performance. The internal database, for example, is stored in the data store. If the data sources were insufficient, the video robot system is capable to self-generate data using a generative adversarial network (GAN) or other generative systems to create more data for training and testing. In addition, the system is also able to use the internet to download more images or videos for training and testing deployments.

A general purpose dataset plays an important role in obtaining an insight of the performance of the solution provided by the video robot system. In one embodiment, the video robot system constructs a dataset from internal and external resources. The video robot system collects and updates open-source data, which includes images and video clips. The open-source data is saved in the internal storage module. The dataset includes a public dataset. The public dataset includes various types of data, such as those for research purposes as well as those collected from search engines.

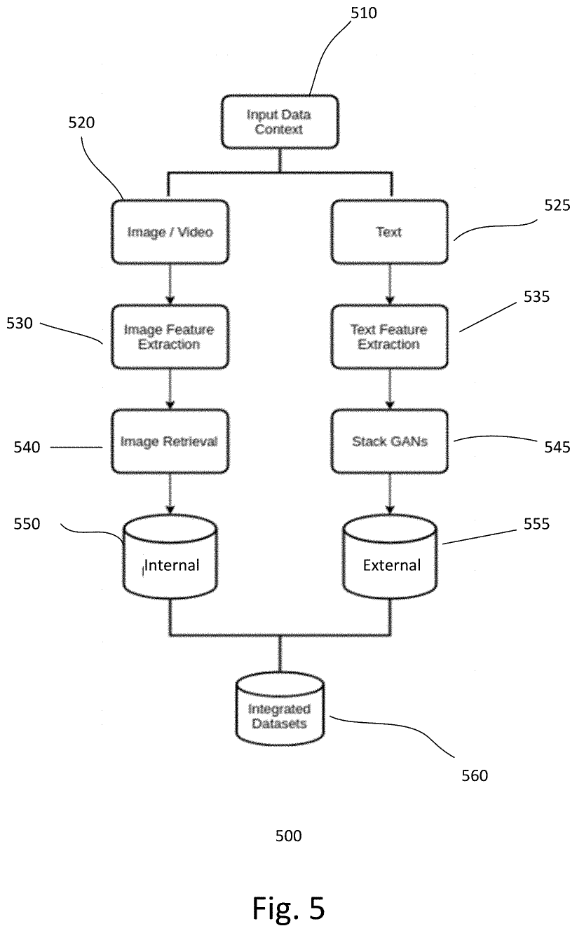

FIG. 5 shows a flow for generating an integrated dataset 500 for testing of the cognitive system. As shown, input data context is provided to the video robot system at 510. Image data from the input context data serves as data for the internal dataset at 520. The image data, for example, include images and videos. At 530, the image data is processed to extract image features. The image data is encoded by image retrieval techniques followed by deep hash for fast indexing at 540. The image data, based on the requirement, is processed and matched with existing dataset in hash code format to build the internal dataset at 550.

On the other hand, input context data which is text data is processed for the external dataset at 525. The text data is processed at 535. Processing includes text feature extraction. At 545, stack GANs are applied to the processed text data to generate synthetic images. The synthetic images serve as an external dataset at 555. The internal and external datasets are combined or integrated at 560. The integrated dataset may be further split into partitions for training, validation and testing. An operator can generate different datasets by incorporating different query images or texts to increase data diversity to achieve a reliable and comprehensive dataset.

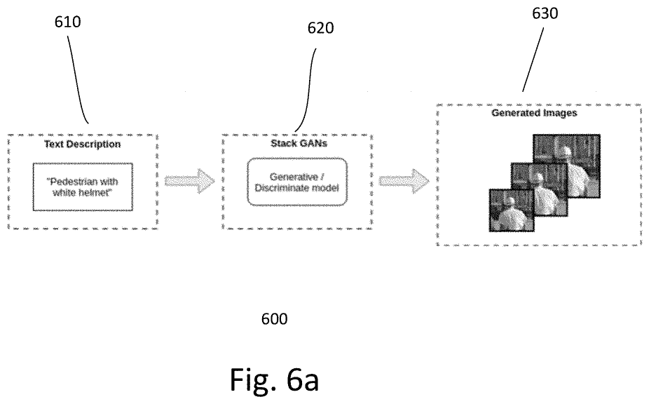

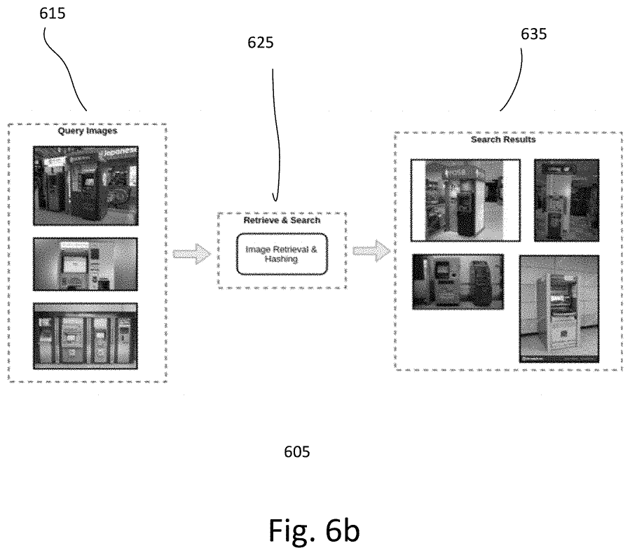

FIG. 6a shows an example of a process 600 for generating synthetic images from text using stack GANs. At 610, text data is provided to the video robot system. The text data includes a description. As shown, the text data is “Pedestrian with white helmet”. Stack GANs is applied to the text data at 620. Stack GANs generates images based on the text data at 630.

FIG. 6b shows an exemplary embodiment of an image retrieval process 605. The operator at 615 provides a set of query images to the video robot system. At 625, the system performs image retrieval and hashing. The search results of the query are shown at 635.

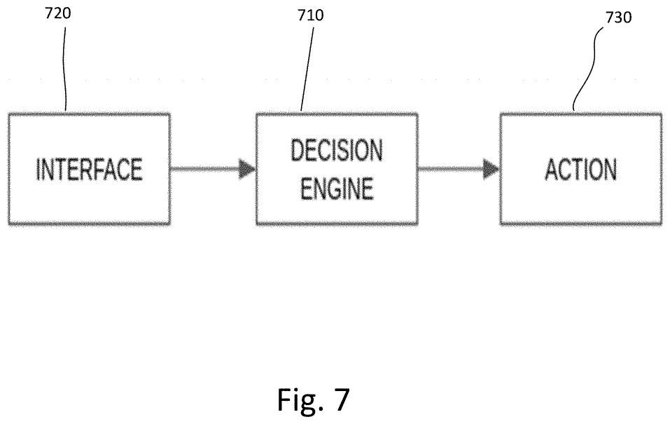

FIG. 7 shows a simplified diagram of a decision engine module 710 of a cognitive system. As discussed, the decision engine can send information to a pre-identified external ecosystem of partners and entities, like law enforcement authorities, automatically when an event is detected or on request with mission-critical information.

The decision engine ingests data available to it through its trusted platforms. For example, data is received via an input interface 720. The decision engine is capable of creating context-awareness without human intervention. The decision engine is able to identify threats, anomalies, issues as well as other types of events. Based on the identified event, the decision engine devises corrective or preventive action. In addition, the decision engine identifies the players and actors who can mitigate the threat. The system is capable to interact with external agencies and entities (players), such as law enforcement, to act on its detected event through pre-programmed medium on how data should be sent out to the actors, for example, by email, application programming interface (API) or other communication techniques via the action interface 730. The system can follow a suspect through installed security cameras and other sensors and guide the law enforcement personnel to the suspect as well as guide the paramedics to the scene of crime so that they can provide assistance to the victims if necessary.

In addition, the system can have remote communications to physical robots or drones. This capability is instrumental in automating incident response related to security or safety issues. For example, the system can manage a swarm of drones for fast response to the incident until specialized human intervention arrives at the site.

Additionally, the decision engine module of the video robot system infers and requests information about the users who are sending requests to consume the video robot system's data output for ad hoc queries. Such information contains important interconnection and approval data that best describes the user, for example, geolocation, organization, device type, roles and functions during intermediation, such as in the case of a robbery.

In an exemplary scenario, the video robot system detects a fire. The video robot may become aware of the situation by communicating with an IoT temperature command system. The system creates and broadcasts an evacuation plan, which includes a safe route for the residents after evaluating the extent of the spread of fire via loudspeakers installed in the building. The system then checks if fire suppression has been activated. The video system can also switch to an active human viewing mode in case the engine detects that the fire has cut off fire alarms or the sprinkler system.

The system not only sends notifications to respective authorities about the fire but also finds nearby responders whom will receive photos and details on the whereabouts of the residents who are stuck in the building. Based on this specific instance, the decision engine creates a response plan that will highlight photos and details about the location of the residents stuck in the building. This facilitates faster evacuation residents by the firemen.

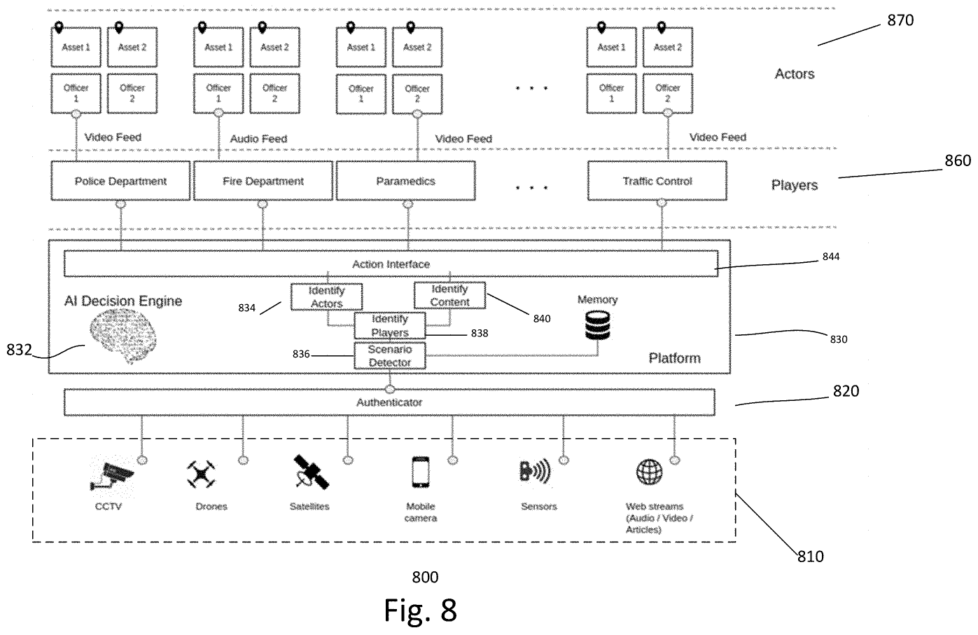

FIG. 8 shows various aspects of the video robot system 800 for an exemplary scenario of a fire. The lowest layer of the video robot system is the data ingestion layer 810. The data ingestion layer, for example, is part of the input interface which includes an authenticator 820 for authenticating the data. An AI decision engine 832 is the centerpiece for processing and inference. As shown, the decision engine is part of the system platform 830. The action interface 844 is designed to be platform agnostic. The geo-tagged Players 860 and Actors 870 can then be directed by the Decision Engine.

The decision engine has universal applications as well as various ecosystems to cater to. As such, the decision engine is configured to be highly compatible with all the other systems in play. The system also supports multiple external ecosystems of partners and entities, such as like law enforcement, emergency paramedical agencies, fire department, national guards as well as other entities. The decision engine, in one embodiment, operates using middleware which is system agnostic, enabling it to communicate with any agency, including legacy services wherever possible.

A key capability of the system is to efficiently coordinate its video knowhow to event responders or security guards, which requires “open” standards and interfaces. This will expedite rescue, attacker interdiction and prevent crimes without compromising data privacy. Furthermore, the system sends the right information to the right party that is well packaged and complete.

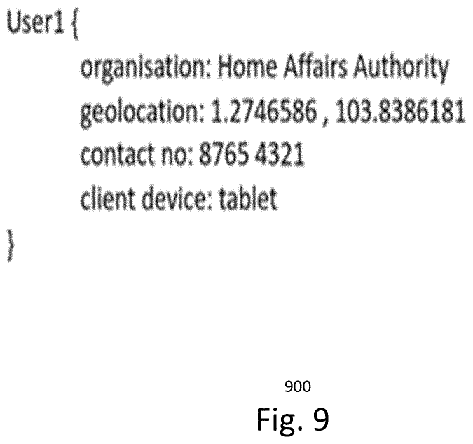

The video robot system may utilize information of the users, such as actors and players, to create incident response plans and contextual decisions on relaying messages to the authorities. FIG. 9 represents a user's information that is being used by the decision engine. As shown, the information represents the user and location. Other information includes the user's contact information as well as the type of device of the user. For example, based on the user information, the system knows that Home Affairs is on its way to the scene. In addition, based on the geolocation, the system knows that Home Affairs is close to the scene. Using the user's information, the system makes a contextual decision that it makes the most sense to send them photos of where the residents are stuck and in which room they are located.

The platform can be any set of existing data points joined together into a single source of reliable information or individual reliable sources of data points that are designed to be consumed by the decision engine.

Referring back to FIG. 8, the platform includes a scenario detector 836. The scenario detector is configured to detect the type of incident or emergency. Based on the type of emergency, the scenario detector decides on the type of “players” that would be involved in the incident. For example, in case of a fire, the scenario detector will involve the fire department for quick assistance and will request for dispatching the paramedics. Also depending on the situation, it can keep the police department on standby and activate the traffic police to control and re-route the traffic so that the emergency services can reach the scene easily. It will have access to information regarding individual relevant “actors” who can execute the required action to mitigate the emergency. The scenario detector also decides on the “content” that it can share with the actors so as to facilitate faster recovery.

The platform also includes an action interface 844. The action interface serves as the trigger point that prompts the decision engine to send notifications/messages to respective parties. This layer executes the decision made by the decision engine and delivers the data to the actors' receiving device in the correct and compatible format. For instance, if the recipient is using a low bandwidth portable device, instead of streaming a video, or audio record, the content is automatically translated into text form, enabling the low bandwidth device to receive the information. In addition, the action interface supports an omnichannel interface.

The platform further includes an identify players unit 838, an identify actors unit 834 and an identify content unit 840. Once the problem statement or issue is generated, e.g., high level classification of the scenario, the identity unit identifies the players, such as the authorities or agencies, that are capable of attending to the “detected issue”. The system informs the players of the detected issue.

The identify actors unit identifies the person or department of the relevant authority that is most suited to deal with the scenario at hand. Individuals can be, for example, the information about the person/department. The information should be as granular as possible to supply as much information as possible to the decision engine. The information may be an authorization of the personnel, key competencies, geo-location and access to interfacing-equipment. This facilitates in the decision engine in deciding which is the best response to the issue at hand

The identify content unit contains the content of information which is the output of the decision engine. For example, the output is the information as to what makes sense as well as the next steps based on the scenario. The decision engine is allowed to decide on the format of the information which is handled by each actor. As an example, if the firemen have access to hand-held walkie-talkies but have no access to video feeds, the decision engine can then decide to route the relevant information through Audio channels or to translate the content into text into an audio recording for playback (text to speech). This ensures that the firemen receive the information.

The decision engine creates its own contextual reasoning as to who, how, when, and where the data should be sent to, depending on the current scenario and users. As the video robot has inherent situational awareness from its connected sensors, e.g., cameras and transducers, it can pass the interfaces over to human responders efficiently by predicting what information is needed and what will be needed to comprehend an ongoing situation on the ground, facilitating direct access to the available sensors.

The inventive concept of the present disclosure may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for performing automated video analysis comprising:
receiving input data from different data sources;
processing the input data, wherein processing the input data comprises identifying and extracting information based on a predefined purpose;
performing analytics using the information, wherein performing analytics includes identifying one or more scenarios to determine a situation; and
generating a correct preventive plan based on the determined situation, wherein the automated video analysis is configured to simplify multimedia processing of complicated multi-state actions embedded within a video.
